(19) United States
(12) Patent Application Publication
(10) Pub. No.: US 2009/0281258 A1
(43) Pub. Date: Nov. 12, 2009

(54) Amine Promoter Blends For Peroxide-Initiated Curing Systems

(75) Inventor: Wenfeng Kuang, Baton Rouge, LA (US)

Correspondence Address: ALBEMARLE CORPORATION, 451 FLORIDA STREET, BATON ROUGE, LA, 70801-1765, US

(73) Assignee: Albemarle Corporation, Baton Rouge, LA (US)

(21) Appl. No.: 12/296,862

(22) PCT Filed: Sep. 28, 2006
(86) PCT No.: PCT/US06/38053

§ 371 Date: Oct. 10, 2008

Related U.S. Application Data
(60) Provisional application No. 60/791,676, filed on Apr. 12, 2006.

(51) Int. Cl. C08F 2/00; C09K 3/00; C08F 4/42

(52) U.S. Cl. 526/90; 252/182.13; 526/217

(57) ABSTRACT

Amine blend cure promoters comprising aromatic and tertiary alkyl amines are disclosed for promoting the cure of unsaturated polymer resins with a peroxide initiator, as well as methods for promoting the cure of such resins.

### FIELD OF THE INVENTION

The present invention relates to amine promoter blends for curing unsaturated polymer resins with a peroxide initiator and methods of using the same.

### DESCRIPTION OF RELATED ART

The term polyester refers generally to the group of synthetic resins that are polycondensation products of dicarboxylic acids with dihydroxy alcohols. The term unsaturated polyester resin, as used herein, designates a linear-type alkyd possessing carbon-to-carbon double bond unsaturation in the polymer chain. These unsaturated polyesters may be crosslinked (cured) by reaction with monomers such as styrene or diallyl-phthalate, usually in the presence of a peroxide to form insoluble and infusible resins without the formation of a by-product during the curing reaction. Other types of polymer resins are also known which include carbon-to-carbon double bond unsaturation in the polymer chain, and which can also be crosslinked/cured, such as urethane acrylates, epoxy acrylates, and the like.

Tertiary aromatic amines are widely used as cure promoters or accelerators for unsaturated resins in the presence of peroxide initiators. Exemplary tertiary amines useful as cure promoters in such systems include, for example, N,N-dimethylaniline (DMA), N,N-diethylaniline (DEA), N,N-bis-(2-hydroxyethyl)-m-toluidine, N,N-bis-(2-hydroxyethyl)-p-toluidine (HEPT), N,N-dimethyl-p-toluidine (DMPT), and N-methyl-N-(2-hydroxyethyl)-p-toluidine (MHPT).

Tertiary alkyl amines are used in a variety of applications including as catalyst in certain polymerization systems, they are not regarded as sufficient promoters for peroxide-initiated curing systems.

### DETAILED DESCRIPTION OF THE INVENTION

As stated above, the present invention relates generally to amine promoter blends for curing unsaturated polymer resins with a peroxide initiator and methods of using the same. More specifically, it relates to blends of tertiary aromatic amines and tertiary alkyl amines used as promoters to accelerate polymerization of peroxide-initiated curing systems.

### Tertiary Aromatic Amines

Tertiary aromatic amines that are suitable for use in the present invention have the following structure, Formula I:

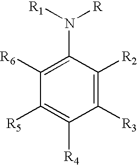

wherein:
R₁ is a linear or branched C₁ to C₆ alkyl or C₃ to C₆ cycloalkyl;
R is a linear or branched C₁ to C₆ alkyl, C₃ to C₆ cycloalkyl, or has the structure of Formula II:

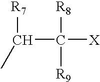

wherein, R₇ is hydrogen, linear or branched C₁ to C₆ alkyl or C₃ to C₆ cycloalkyl, wherein said C₁ to C₆ alkyl or C₃ to C₆ cycloalkyl is optionally substituted at the C₁ or C₃ position, respectively, by X as defined below, R₈ and R₉ are each independently selected from the group consisting of hydrogen, linear or branched C₁ to C₆ alkyl, and C₃ to C₆ cycloalkyl, and X is OH, OR₁, CN, OC(O)R₁, O[(CH₂)ₘO]ₙH or O[(CH₂)ₘO]ₙR₁, wherein m=1 to 6 and n=1 to 6, and wherein R₁ is as defined above, and
R₂, R₃, R₄, R₅, and R₆ are each independently selected from the group consisting of hydrogen, linear or branched C₁ to C₆ alkyl, C₃ to C₆ cycloalkyl, and C₁ to C₆ alkoxy.

Exemplary tertiary aromatic amines having the structure Formula I include, but are not limited to, DMA, DEA, HEPT, DMPT, MHPT, and mixtures of two or more of the foregoing.

Preferred tertiary aromatic amines that are suitable for use in the present invention have the following structure, Formula III:

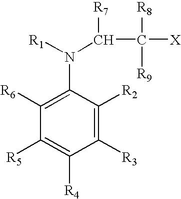

wherein R₁, R₂, R₃, R₄, R₅, R₆, R₇, R₈, R₉ and X are defined as above.

As used herein, the term “C₁ to C₆ alkyl” refers to C₁ to C₆ linear or branched alkyl, such as methyl, ethyl, propyl, butyl, isopropyl, sec-butyl, and tert-butyl, butyl, pentyl, isopentyl, and hexyl. The term “C₃ to C₆ cycloalkyl” as used herein refers to C₃ to C₆ cyclic alkyl, such as cyclopropyl, cyclobutyl, cyclopentyl, and cyclohexyl. The term “C₁ to C₆ alkoxy” as used herein refers to C₁ to C₆ linear or branched oxygen-substituted alkyl, such as methoxy, ethoxy, propyloxy, butyloxy, isopropyloxy, and t-butyloxy.

More preferred compounds of Formula (III) have the following substituents:

R₁ is methyl or ethyl;
R₇ is hydrogen or hydroxymethyl;
R₈ or R₉ are each independently selected from the group consisting of hydrogen, methyl and ethyl;
R2, R3, R4, R5, and R6 are each independently selected from the group consisting of hydrogen and methyl, and
X is OH or O[(CH2)mO]nH, wherein m=2 and n=1 to 6.

Exemplary tertiary aromatic amines of Formula III include, but are not limited to, N-methyl-N-(2-hydroxyethyl)-p-toluidine (MHPT); N-ethyl-N-(2-hydroxyethyl)-p-toluidine (EHPT); N-methyl-N-(2-hydroxypropyl)-p-toluidine (2HPMT); and mixtures thereof.

### Tertiary Alkyl Amines

Tertiary alkyl amines suitable for use in the present invention include, but are not limited to, tertiary amines of the formula R₃N, wherein R is independently selected from the group consisting of C₁ to C₃₂ alkyl groups. Exemplary tertiary alkyl amines include, but are not limited to, N,N-alkyl dimethyl amines, wherein the alkyl group comprises 2 to 32 carbon atoms, such as, for example, N,N-dimethyl octyl amine (ADMA-8), N,N-dimethyl decyl amine (ADMA-10), N,N-dimethyl dodecyl amine (ADMA-12), N,N-dimethyl tetradecyl amine (ADMA-14), N,N-dimethyl hexadecyl amine (ADMA-16), N,N-dimethyl octadecyl amine (ADMA-18), and mixtures thereof, and dialkyl methylamines, wherein the alkyl groups comprise 2 to 32 carbon atoms, such as, for example, dioctylmethylamine, didecylmethylamine, didodecylmethylamine, ditetradecylmethylamine, dihexadecylmethylamine, and mixtures thereof.

The blend of tertiary aromatic amines and tertiary alkyl amines can be used in quantities between about 10 wt ppm and about 5 percent by weight, preferably in quantities between about 50 wt ppm and about 2 percent by weight, and more preferably between about 100 wt ppm and about 0.5 percent by weight, based on weight of the unsaturated resin. It should be noted that preferred embodiments of the present invention contemplate that all ranges discussed herein include ranges from any lower amount to any higher amount. For example, when discussing concentration between about 10 wt ppm and about 5 percent by weight, ranges can include concentrations in the range of from about 10 wt ppm to about 2 percent by weight, in the range from about 100 wt ppm to about 2 percent by weight, etc.

The amount of tertiary alkyl amine in the blend of the two amines can range from about 0.01 to about 99.9 percent by weight based upon the weight of the blend. However, utilizing an appropriate amount of tertiary alkyl amine (herein referred to as an “promoting efficiency maximizing amount”), which may depend upon the amines being used, can maximize the efficiency of the blend as a promoter. For example, when using MHPT and ADMA-16, the amount of tertiary alkyl amine that maximizes efficiency of the blend ranges from about 85 to about 40 percent by weight, preferably between about 85 to about 60 percent by weight.

### Preparation of Tertiary Aromatic Amines

The tertiary aromatic amines suitable for use in the invention can be prepared using techniques as known in the art, for example, alkylation of an appropriate N-alkyl-p-toluidine to provide, for example, an N-alkyl-N-(2-hydroxyalkyl)-p-toluidine. For example, MHPT can be prepared by adding a slight molar excess of ethylene oxide to N-methyl-p-toluidine and subjecting the mixture to conditions sufficient to ethoxylate the toluidine compound. The ethoxylation can be performed by methods known in the art.

The tertiary aromatic amines of the present invention can also be synthesized by alkylation of an appropriate N-hydroxyalkyl-p-toluidine. For example, MHPT can be prepared by adding formaldehyde and hydrogen to a mixture of N-hydroxyethyl-p-toluidine and palladium on a carbon catalyst under appropriate temperature and pressure conditions, such as at 120° C. and 120 psig.

The material obtained by the first route is usable directly out of the reactor. No further purification is required, but distillation can be performed to provide a purer product. The material from the second route should be purified before use. Commercially available tertiary aromatic amines include ADMA-8, ADMA-10, ADMA-12, ADMA-14, ADMA-16, ADMA-18, ADMA-1214, ADMA-1416, ADMA-246-451, ADMA-246-621, and DAMA-1010, all manufactured by Albemarle® Corporation.

### Preparation of Tertiary Alkyl Amines

The tertiary alkyl amines suitable for use in the invention can be prepared using techniques as known in the art, for example, direct alkylation of secondary amines of alkyl halides in the presence of Huenig's base.

### Resins

Polyesters which are useful according to the present invention include conventional unsaturated polyester resins known in the art. Thus, the unsaturated polyesters may be obtained by reaction of approximately equivalent amounts of a polyvalent alcohol such as ethylene glycol, diethylene glycol, triethylene glycol, trimethylene glycol, propylene glycol, pentaerythritol, and other diols or polyols with an unsaturated dibasic carboxylic acid or carboxylic anhydride such as maleic acid, maleic anhydride, fumaric acid, itaconic acid, or citraconic acid. These unsaturated dibasic carboxylic acids or anhydrides are often used in combination with aromatic and/or saturated aliphatic dicarboxylic acids or the anhydrides derived therefrom, such as phthalic acid, phthalic anhydride, isophthalic acid, tetrachlorophthalic acid, malonic acid, adipic acid, sebacic acid, tartaric acid, and the like.

Unsaturated polyesters containing vinyl groups or vinylidene groups may be obtained by polycondensation of alpha, beta-unsaturated monocarboxylic acids such as acrylic or methacrylic acid, with mono-, di- or polyhydric alcohols. Exemplary alcohols include methanol, ethanol, isopropanol, cyclohexanol, phenol, ethylene glycol, propylene glycol, 2,2-bis(4-hydroxyphenyl)propane, 2,2-bis(4-hydroxycyclohexyl)propane, 2,2-bis(4-beta-hydroxyethyloxy-phenyl)propane, pentaerythritol and dimers thereof, trimethol propane and a glycerol, and the complex diols or polyols. Unsaturated polyesters containing vinyl groups or vinylidene groups also may be obtained by reacting alpha, beta-unsaturated monocarboxylic acids with compounds containing epoxy groups, such as bisphenol A bis(glycidyl ether).

Further, the unsaturated polyesters can be dissolved in monomers copolymerizable with the polyester, which contain one or more C═C groups such as styrene, vinyl toluene, methylmethacrylate, ethyleneglycolmethacrylate, and the like, as is also conventional. The preferred solutions are those which contain from about 70 to 50 percent by weight of unsaturated polyester and 30 to 50 percent by weight of copolymerizable monomer. Styrene is a preferred copolymerizable monomer.

Although the invention has been described in detail with regard to the use of amine promoter blends as cure promoters for unsaturated polyester resins, the skilled artisan will appreciate that the compounds of the invention can also be used with other unsaturated polymers capable of being cured using peroxide initiators. Such unsaturated polymers include conventional polyurethane acrylate resins known in the art. The unsaturated polyurethane may be obtained by reaction of a polyisocyanate, such as toluene diisocyanate, diphenylmethane diisocyanate, hexamethylene diisocyanate, and the like, with an appropriate compound containing at least two active hydrogen atoms, such as a polyol or a polyamine. Exemplary polyols include ethylene glycol, diethylene glycol, triethylene glycol, trimethylene glycol, propylene glycol, pentaerythritol, and other diols or polyols. Urethane polymers may be used in the form of homopolymers or, more preferably, with various other monomers which can be copolymerized therewith. For example, urethane polymers can be prepared by reacting any of a variety of acrylic comonomers, such as acrylic and methacrylic acids, and their amides, esters, salts and corresponding nitriles, with the polyurethane resin. Particularly suitable comonomers for such polymers are methyl methacrylate, ethyl acrylate and acrylonitrile.

Yet another exemplary unsaturated polymer that can be treated using the blends of the present invention include unsaturated epoxy resins known in the art. Unsaturated epoxy resins may be obtained by reaction of an epoxide group (resulting from the union of an oxygen atom with two other atoms, usually carbon), such as epichlorohydrin, oxidized polyolefins, for example ethylene oxide, with an aliphatic or aromatic alcohol such as bisphenol A, glycerol, etc. As with the unsaturated polymers described above, the epoxy resins may be used in the form of homopolymers or copolymers with various other comonomers which can be reacted therewith, including various acrylic monomers, such as acrylic and methacrylic acids, and their amides, esters, salts and corresponding nitrites.

### Initiators

The polymerization or copolymerization initiators which can be used are those conventionally available and include hydrogen peroxide, the ketone peroxides, such as acetylacetone peroxide, methylethylketone peroxide, cyclohexanone peroxide and methylisobutylketone peroxide; the diacyl peroxides, such as benzoyl peroxide, lauroyl peroxide, isobutyryl peroxide, acetyl peroxide, 2,4-dichlorobenzoyl peroxide, succinic acid peroxide, decanoyl peroxide, diisononanoyl peroxide; the peresters, such as tert-butyl peroxide-2-ethyl hexanoate; the perketals, such as 1,1-ditert-butylperoxy-3,3,5-trimethyl cyclohexane and dialkyl peroxides, such as 1,3-bis(tert-butylperoxyisopropyl)benzene. The diacyl peroxides, and particularly benzoyl peroxide, are the preferred initiators. The initiators are used in amounts known in the art, for example, for peroxide initiators, between about 0.5 and 10 percent by weight.

### Co-Promoters

The amine promoter blends of the present invention can be used alone or with other cure promoters, such as other tertiary aromatic amines, metal salts, and the like, and mixtures thereof. Examples of metal salts useful as cure promoters include cobalt, vanadium, zirconium, iron, manganese, chromium, tin, aluminum, lead, and copper salts, and the like, and mixtures of any two are more of the foregoing. Preferably such metal salts comprise a metal salt of a carboxylic acid, such as a C₆-C₂₀ fatty acid, benzoic acid, naphthalenic acid, and the like. Cobalt naphthenate is one advantageous metal salt cure promoter.

### Example 1

Various amine promoter blends of N-methyl-N-(2-hydroxyethyl)-p-toluidine (MHPT) and N,N-dimethyl hexadecyl amine (ADMA-16) were compared to determine the optimum ratio of the aromatic and tertiary alkyl amine components. Gel times for curing an unsaturated polyester resin (Bondo® #100219) in a cobalt naphthenate/methylethylketone peroxide system were recorded. All tests were conducted at 24° C. The results of the test are shown in Table 1 below.

TABLE 1

| | | | | | | | | |
|---|---|---|---|---|---|---|---|---|
| Bondo Resin | 9.85 | 9.85 | 9.85 | 9.85 | 9.85 | 9.85 | 9.85 | 9.85 |
| #100219, g | | | | | | | | |
| MHPT, g | 0.10 | 0.09 | 0.08 | 0.06 | 0.04 | 0.02 | 0.015 | 0 |
| ADMA-16, g | 0 | 0.01 | 0.02 | 0.04 | 0.06 | 0.08 | 0.085 | 0.10 |
| Co | 0.05 | 0.05 | 0.05 | 0.05 | 0.05 | 0.05 | 0.05 | 0.05 |
| Naphthenate | | | | | | | | |
| (12%), g | | | | | | | | |
| MEKP, g | 0.2 | 0.2 | 0.2 | 0.2 | 0.2 | 0.2 | 0.2 | 0.2 |
| Gel time, min | 6.67 | 6.2 | 5.5 | 4.82 | 4.63 | 3.85 | 4.13 | 14.5 |

The optimum blend of MHPT and ADMA-16 is between 15 wt % and 40 wt %. For the purposes of this experiment, the optimum blend is assumed to be 20 wt % MHPT and 80 wt % ADMA-16.

In comparison, the gel times for the same system utilizing only MHPT as a promoter were significantly greater. The results of this comparison are shown in Table 2.

TABLE 2

| | | | | |
|---|---|---|---|---|
| Bondo resin #100219, g | 9.85 | 9.85 | 9.85 | 9.85 |
| MHPT, g | 0.08 | 0.06 | 0.04 | 0.02 |
| Cobalt Naphthenate (12%), g | 0.05 | 0.05 | 0.05 | 0.05 |
| MEKP, g | 0.2 | 0.2 | 0.2 | 0.2 |
| Gel time, min | 7.2 | 8.1 | 9.3 | 10.9 |

### Example 2

The optimum promoter blend of Example 1 (20% MHPT and 80% ADMA-16) was used to cure a different unsaturated polyester resin (Aropol® 7221) in a cobalt naphthenate/methlyethylketone peroxide system. As in Example 1, all tests were conducted at 24° C. The effect on gel time of increasing amounts of the promoter blend are shown in Table 3.

TABLE 3

| | | | | | |
|---|---|---|---|---|---|
| Aropol 7221, g | 9.935 | 9.945 | 9.955 | 9.965 | 9.975 |
| Amine promoter blend, g | 0.05 | 0.04 | 0.03 | 0.02 | 0.01 |
| Cobalt Naphthenate (12%), g | 0.015 | 0.015 | 0.015 | 0.015 | 0.015 |
| MEKP, g | 0.1 | 0.1 | 0.1 | 0.1 | 0.1 |
| Gel time, min | 7.6 | 8.1 | 8.7 | 9.5 | 11.1 |

In comparison, the gel times for the same amount of DMPT as a promoter in the same system were significantly greater. The results of this comparison are shown in Table 4.

TABLE 4

| | | | | | |
|---|---|---|---|---|---|
| Aropol 7221, g | 9.935 | 9.945 | 9.955 | 9.965 | 9.975 |
| DMPT, g | 0.05 | 0.04 | 0.03 | 0.02 | 0.01 |
| Cobalt Naphthenate | 0.015 | 0.015 | 0.015 | 0.015 | 0.015 |
| (12%), g | | | | | |
| MEKP, g | 0.1 | 0.1 | 0.1 | 0.1 | 0.1 |
| Gel time, min | 10.2 | 12 | 16.1 | 17 | 22.2 |

While the compositions and methods of this invention have been described in terms of preferred embodiments, it will be apparent to those of skill in the art that variations may be applied to the compositions, methods and/or processes and in the steps or in the sequence of steps of the methods described herein without departing from the concept and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the scope and concept of the invention.

1) An amine promoter blend for curing a peroxide-initiated unsaturated polymer resin system comprising at least one tertiary aromatic amine and at least one tertiary alkyl amine.

2) The amine promoter blend of claim 1, wherein the at least one tertiary aromatic amine has the structure: 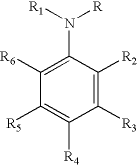
wherein:
R₁ is a linear or branched C₁ to C₆ alkyl or C₃ to C₆ cycloalkyl;
R is a linear or branched C₁ to C₆ alkyl, C₃ to C₆ cycloalkyl, or has the structure: 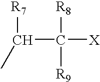
wherein, R₇ is hydrogen, linear or branched C₁ to C₆ alkyl or C₃ to C₆ cycloalkyl, wherein said C₁ to C₆ alkyl or C₃ to C₆ cycloalkyl is optionally substituted at the C₁ or C₃ position, respectively, by X as defined below, R₈ and R₉ are each independently selected from the group consisting of hydrogen, linear or branched C₁ to C₆ alkyl, and C₃ to C₆ cycloalkyl, and X is OH, OR₁, CN, OC(O)R₁, O[(CH₂)ₘO]ₙH or O[(CH₂)ₘO]ₙR₁, wherein m=1 to 6 and n=1 to 6, and wherein R₁ is as defined above; and
R₂, R₃, R₄, R₅, and R₆ are each independently selected from the group consisting of hydrogen, linear or branched C₁ to C₆ alkyl, C₃ to C₆ cycloalkyl, and C₁ to C₆ alkoxy.

3) The amine promoter blend of claim 2, wherein the at least one tertiary aromatic amine has the structure: 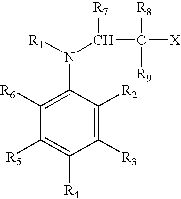
wherein:
R₁ is methyl or ethyl;
R₇ is hydrogen or hydroxymethyl;
R₈ or R₉ are each independently selected from the group consisting of hydrogen, methyl and ethyl;
R₂, R₃, R₄, R₅, and R₆ are each independently selected from the group consisting of hydrogen and methyl; and
X is OH or O[(CH₂)ₘO]ₙH, wherein m=2 and n=1 to 6.

4) The amine promoter blend of claim 3, wherein the at least one tertiary aromatic amine is N-methyl-N-(2-hydroxyethyl)-p-toluidine, N-ethyl-N-(2-hydroxyethyl)-p-toluidine, or N-methyl-N-(2-hydroxypropyl)-p-toluidine.

5) (canceled)

6) The amine promoter blend of claim 1, wherein the at least one tertiary alkyl amine has the structure R₃N, wherein R is independently selected from the group consisting of C₁ to C₃₂ alkyl groups, and wherein the at least one tertiary alkyl amine is an N,N-alkyl dimethyl amine.

7) (canceled)

8) The amine promoter blend of claim 6, wherein the at least one tertiary alkyl amine is N,N-dimethyl hexadecyl amine.

9) (canceled)

10) A curable unsaturated resin system comprising a peroxide initiator and an amine blend cure promoter, wherein the amine blend cure promoter comprises at least one tertiary aromatic amine and at least one tertiary alkyl amine.

11) The curable unsaturated resin system of claim 10, wherein the at least one tertiary aromatic amine has the structure: 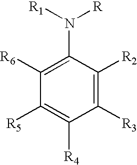
wherein:
R₁ is a linear or branched C₁ to C₆ alkyl or C₃ to C₆ cycloalkyl;
R is a linear or branched C₁ to C₆ alkyl, C₃ to C₆ cycloalkyl, or has the structure: 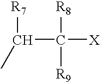
wherein, R₇ is hydrogen, linear or branched C₁ to C₆ alkyl or C₃ to C₆ cycloalkyl, wherein said C₁ to C₆ alkyl or C₃ to C₆ cycloalkyl is optionally substituted at the C₁ or C₃ position, respectively, by X as defined below, R₈ and R₉ are each independently selected from the group consisting of hydrogen, linear or branched C₁ to C₆ alkyl, and C₃ to C₆ cycloalkyl, and X is OH, OR₁, CN, OC(O)R₁, O[(CH₂)ₘO]ₙH or O[(CH₂)ₘO]ₙR₁, wherein m=1 to 6 and n=1 to 6, and wherein R₁ is as defined above, and
R₂, R₃, R₄, R₅, and R₆ are each independently selected from the group consisting of hydrogen, linear or branched C₁ to C₆ alkyl, C₃ to C₆ cycloalkyl, and C₁ to C₆ alkoxy.

12) The curable unsaturated resin system of claim 11, wherein the at least one tertiary aromatic amine has the structure: 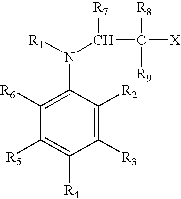
wherein:
R₁ is methyl or ethyl;
R₇ is hydrogen or hydroxymethyl;
R₈ or R₉ are each independently selected from the group consisting of hydrogen, methyl and ethyl;
R₂, R₃, R₄, R₅, and R₆ are each independently selected from the group consisting of hydrogen and methyl, and
X is OH or O[(CH₂)ₘO]ₙH, wherein m=2 and n=1 to 6.

13) The curable unsaturated resin system of claim 12, wherein the at least one tertiary aromatic amine is N-methyl-N-(2-hydroxyethyl)-p-toluidine, N-ethyl-N-(2-hydroxyethyl)-p-toluidine, or N-methyl-N-(2-hydroxypropyl)-p-toluidine.

14) (canceled)

15) The curable unsaturated resin system of claim 10, wherein the at least one tertiary alkyl amine has the structure R₃N, wherein R is independently selected from the group consisting of C₁ to C₃₂ alkyl groups, and wherein the at least one tertiary alkyl amine is an N,N-alkyl dimethyl amine.

16) (canceled)

17) The curable unsaturated resin system of claim 15, wherein the at least one tertiary alkyl amine is N,N-dimethyl hexadecyl amine.

18) The curable unsaturated resin system of claim 10, wherein a promoting efficiency maximizing amount of the at least one tertiary alkyl amine is utilized in the blend.

19) The curable unsaturated resin system of claim 10, wherein the total amount of the amine promoter blend ranges between about 10 wt ppm and about 5 percent by weight, based on weight of the unsaturated resin.

20-21. (canceled)

22) The curable unsaturated resin system of claim 10, further comprising an additional cure promoter.

23) The curable unsaturated resin system of claim 22, wherein the additional cure promoter is at least one metal salt, wherein the additional cure promoter is a metal salt of cobalt, vanadium, zirconium, iron, manganese, chromium, tin, aluminum, lead, or copper, or a mixture thereof.

24) (canceled)

25) The curable unsaturated resin system of claim 23, wherein the metal salt is a metal salt of a carboxylic acid.

26) (canceled)

27) A method for curing an unsaturated polymer resin, comprising crosslinking the unsaturated polymer resin with a peroxide initiator in the presence of an amine blend cure promoter, wherein the amine blend cure promoter comprises at least one tertiary aromatic amine and at least one tertiary alkyl amine.

28) The method of claim 27, wherein the at least one tertiary aromatic amine has the structure: 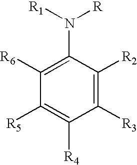
wherein:
R₁ is a linear or branched C₁ to C₆ alkyl or C₃ to C₆ cycloalkyl;
R is a linear or branched C₁ to C₆ alkyl, C₃ to C₆ cycloalkyl, or has the structure: 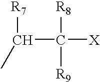
wherein, R₇ is hydrogen, linear or branched C₁ to C₆ alkyl or C₃ to C₆ cycloalkyl, wherein said C₁ to C₆ alkyl or C₃ to C₆ cycloalkyl is optionally substituted at the C₁ or C₃ position, respectively, by X as defined below, R₈ and R₉ are each independently selected from the group consisting of hydrogen, linear or branched C₁ to C₆ alkyl, and C₃ to C₆ cycloalkyl, and X is OH, OR₁, CN, OC(O)R₁, O[(CH₂)ₘO]ₙH or O[(CH₂)ₘO]ₙR₁, wherein m=1 to 6 and n=1 to 6, and wherein R₁ is as defined above, and
R₂, R₃, R₄, R₅, and R₆ are each independently selected from the group consisting of hydrogen, linear or branched C₁ to C₆ alkyl, C₃ to C₆ cycloalkyl, and C₁ to C₆ alkoxy.

29) The method of claim 28, wherein the at least one tertiary aromatic amine has the structure: 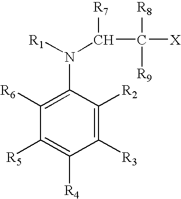
wherein:
R₁ is methyl or ethyl;
R₇ is hydrogen or hydroxymethyl;
R₈ or R₉ are each independently selected from the group consisting of hydrogen, methyl and ethyl;
R₂, R₃, R₄, R₅, and R₆ are each independently selected from the group consisting of hydrogen and methyl, and
X is OH or O[(CH₂)ₘO]ₙH, wherein m=2 and n=1 to 6.

30) The method of claim 29, wherein the at least one tertiary aromatic amine is N-methyl-N-(2-hydroxyethyl)-p-toluidine, N-ethyl-N-(2-hydroxyethyl)-p-toluidine, or N-methyl-N-(2-hydroxypropyl)-p-toluidine.

31) (canceled)

32) The method of claim 27, wherein the at least one tertiary alkyl amine has the structure R₃N, wherein R is independently selected from the group consisting of C₁ to C₃₂ alkyl groups, and wherein the at least one tertiary alkyl amine is an N,N-alkyl dimethyl amine.

33) (canceled)

34) The method of claim 32, wherein the at least one tertiary alkyl amine is N,N-dimethyl hexadecyl amine.

35) (canceled)

36) The method of claim 27, wherein the total amount of the amine promoter blend ranges between about 10 wt ppm and about 5 percent by weight, based on weight of the unsaturated resin.

37-38. (canceled)

39) The method of claim 27, further comprising an additional cure promoter.

40) The method of claim 39, wherein the additional cure promoter is at least one metal salt, and wherein the additional cure promoter is a metal salt of cobalt, vanadium, zirconium, iron, manganese, chromium, tin, aluminum, lead, or copper, or a mixture thereof.

41) (canceled)

42) The method of claim 40, wherein the metal salt is a metal salt of a carboxylic acid.

43) (canceled)
